(19) United States
(12) Patent Application Publication
(10) Pub. No.: US 2013/0343273 A1
(43) Pub. Date: Dec. 26, 2013

(54) ENHANCED TTI BUNDLING WITH FLEXIBLE HARQ MERGING

(71) Applicant: QUALCOMM Incorporated, San Diego, CA (US)

(72) Inventors: Alan BARBIERI, San Diego, CA (US); Hao XU, San Diego, CA (US)

(21) Appl. No.: 13/912,161

(22) Filed: Jun. 6, 2013

Related U.S. Application Data
(60) Provisional application No. 61/664,669, filed on Jun. 26, 2012.

(51) Int. Cl. H04L 1/08

(52) U.S. Cl. CPC H04L 1/08
USPC 370/328

(57) ABSTRACT

A method, an apparatus, and a computer program product for wireless communication are provided in which mandated retransmission of data packets according to a compressed timeline provide an alternative to TTI bundling. A first data unit is transmitted in a first subframe and automatically retransmitted in one or more non-consecutive subframes before a response to a preceding transmission or retransmission of the first data unit has been processed. The retransmissions are terminated after an acknowledgement is processed. The automatic retransmissions occur periodically with a predetermined number of intervening subframes transmitted before each retransmission of the first data unit.

### CROSS-REFERENCE TO RELATED APPLICATION(S)

This application claims the benefit of U.S. Provisional Application Ser. No. 61/664,669, entitled “Enhanced TTI Bundling With Flexible HARQ Merging” and filed on Jun. 26, 2012, which is expressly incorporated by reference herein in its entirety.

### BACKGROUND

1. Field

The present disclosure relates generally to communication systems, and more particularly, to retransmission of data.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

In an aspect of the disclosure, systems, methods and apparatus for mandated retransmission of data packets according to the compressed timeline provide an alternative to TTI bundling.

In an aspect of the disclosure, a first data unit is transmitted in a first subframe and automatically retransmitted in one or more non-consecutive subframes before a response to a preceding transmission or retransmission of the first data unit has been processed. The retransmissions are terminated after an acknowledgement is processed.

In an aspect of the disclosure, the automatic retransmissions occur periodically. A predetermined number of intervening subframes may be transmitted before each retransmission of the first data unit.

In an aspect of the disclosure, a second data unit may be transmitted and retransmitted in the intervening subframes until an acknowledgement of the second data unit is received. The second data unit may be transmitted and retransmitted in non-consecutive subframes. A number of intervening subframes are transmitted before each retransmission of the second data unit. In some embodiments, the same number of intervening subframes is transmitted before retransmissions of the first and second data units. In some embodiments, a different number of intervening subframes is transmitted before retransmissions of the first and second data units.

In an aspect of the disclosure, retransmissions of the first data unit are terminated after a predetermined maximum number of retransmissions. A maximum delay may be defined for the first data unit. The maximum number of retransmissions may be determined based on the maximum delay. The maximum number of retransmissions may be determined based on a number of intervening subframes that are transmitted before each retransmission of the first data unit. The first and/or second data unit may comprise voice data, and may comprise data for transmission through a voice over data network.

In an aspect of the disclosure, a method of wireless communication, comprises providing a grant to a user equipment (UE), granting resources for automatic retransmission of a data unit, receiving a first redundancy version of the data unit, transmitting a response to the first redundancy version of the data unit, and receiving a second redundancy version of the data unit while concurrently transmitting the response.

In an aspect of the disclosure, a negative acknowledgement is transmitted as the response to each of a plurality of redundancy versions of the data unit.

In an aspect of the disclosure, an acknowledgement is transmitted as the response when the data unit can be derived from the plurality of redundancy versions of the data unit.

In an aspect of the disclosure, the grant defines a number of intervening subframes to be transmitted by the UE before each transmission of a redundancy version of the data unit. The grant may define a maximum number of transmissions of redundancy versions of the data unit. The maximum number of transmissions may be based on a maximum delay permitted for the data unit. The first data unit may comprise voice data.

In an aspect of the disclosure, a probability that the data unit can be derived from a next redundancy version of the data unit is determined, and an ACK may be transmitted as a HARQ response when the probability exceeds a threshold. The ACK may be transmitted before the next redundancy version of the data unit is processed. The probability may be determined based on a previously received log-likelihood ratio (LLR). The probability may be determined based on one or more of LLR average energy, LLR average magnitude, intrinsic information in a plurality of LLRs, a number of errors determined after turbo decoding, and an average combined signal-to-interference-and-noise ratio.

### BRIEF DESCRIPTION OF THE DRAWINGS

FIG. 1 is a diagram illustrating an example of network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control planes.

FIG. 6 is a diagram illustrating an example of an evolved Node B and user equipment in an access network.

FIG. 7 is a chart timeline illustrating a compressed HARQ timeline.

FIG. 8 is a chart timeline illustrating a compressed HARQ timeline.

FIG. 9 is a flow chart of a method of wireless communication.

FIG. 10 is a conceptual data flow diagram illustrating the data flow between different modules/means/components in an exemplary apparatus.

FIG. 11 is a diagram illustrating an example of a hardware implementation for an apparatus employing a processing system.

FIG. 12 is a flow chart of a method of wireless communication.

FIG. 13 is a conceptual data flow diagram illustrating the data flow between different modules/means/components in an exemplary apparatus.

FIG. 14 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

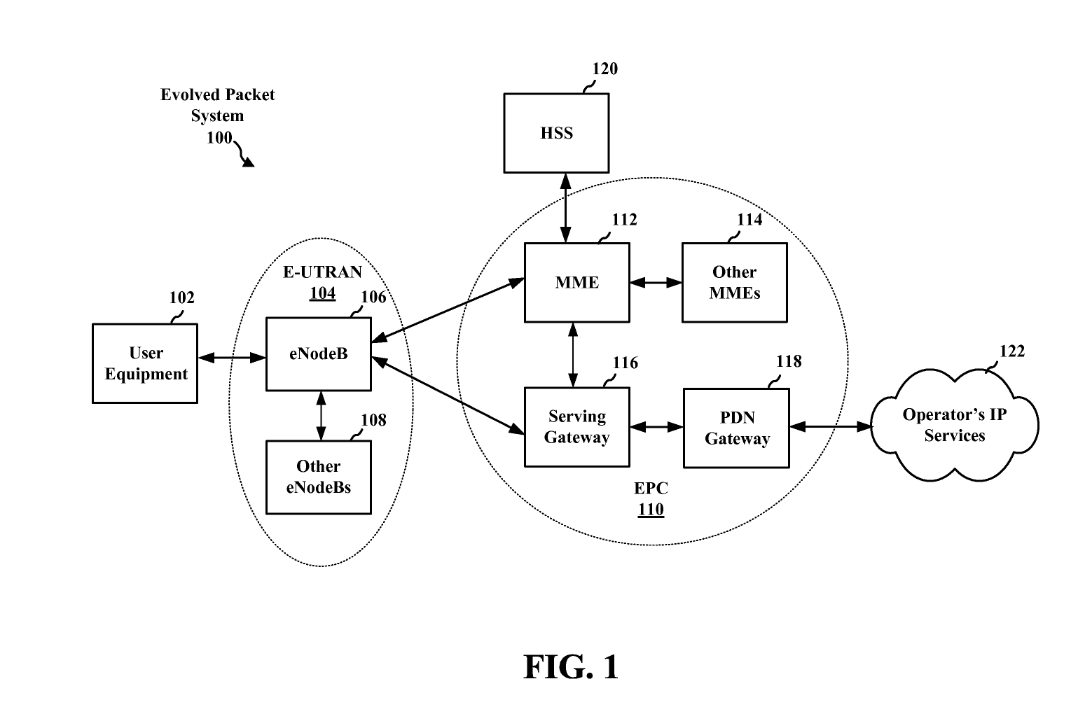

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's IP Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108. The eNB 106 provides user and control planes protocol terminations toward the UE 102. The eNB 106 may be connected to the other eNBs 108 via a backhaul (e.g., an X2 interface). The eNB 106 may also be referred to as a base station, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected by an S1 interface to the EPC 110. The EPC 110 includes a Mobility Management Entity (MME) 112, other MMEs 114, a Serving Gateway 116, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include the Internet, the Intranet, an IP Multimedia Subsystem (IMS), and a PS Streaming Service (PSS).

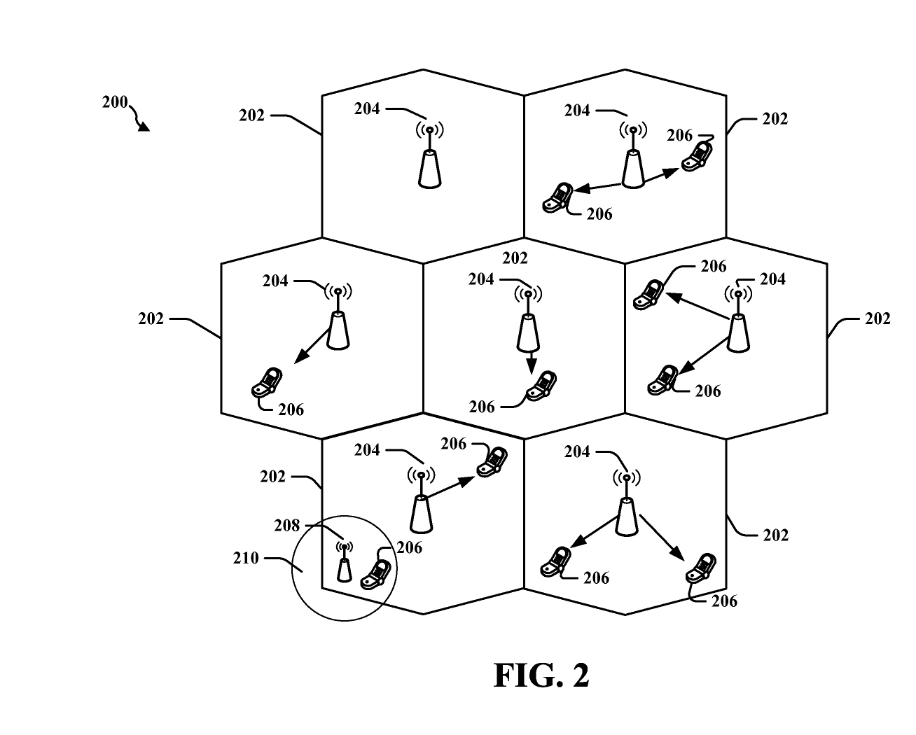

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. The lower power class eNB 208 may be a femto cell (e.g., home eNB (HeNB)), pico cell, micro cell, or remote radio head (RRH). The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116.

The modulation and multiple access scheme employed by the access network 200 may vary depending on the particular telecommunications standard being deployed. In LTE applications, OFDM is used on the DL and SC-FDMA is used on the UL to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data steams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

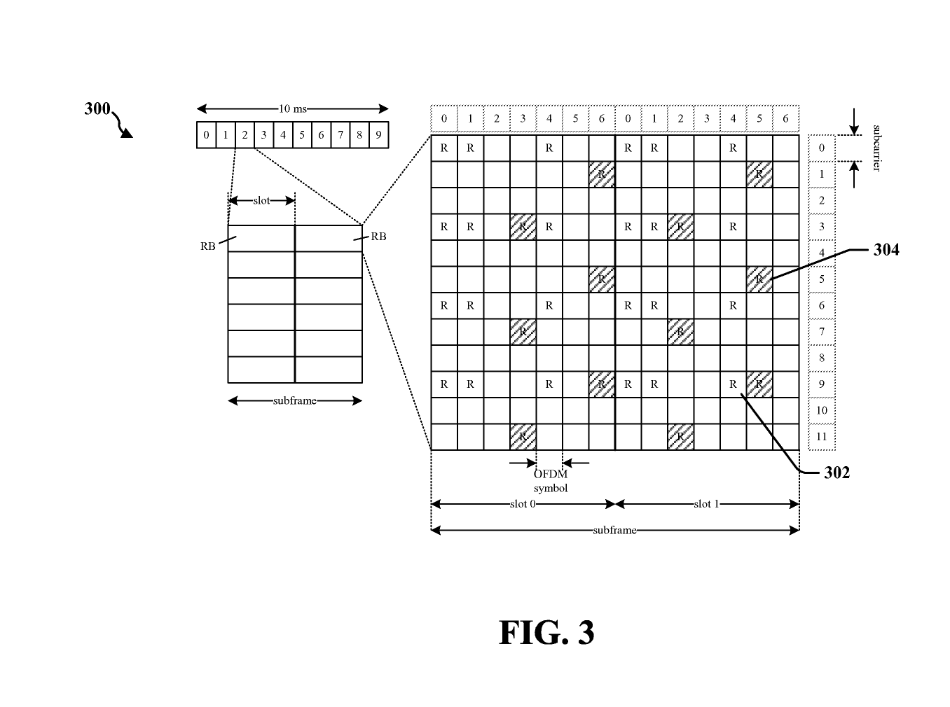

FIG. 3 is a diagram 300 illustrating an example of a DL frame structure in LTE. A frame (10 ms) may be divided into 10 equally sized sub-frames. Each sub-frame may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, as indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

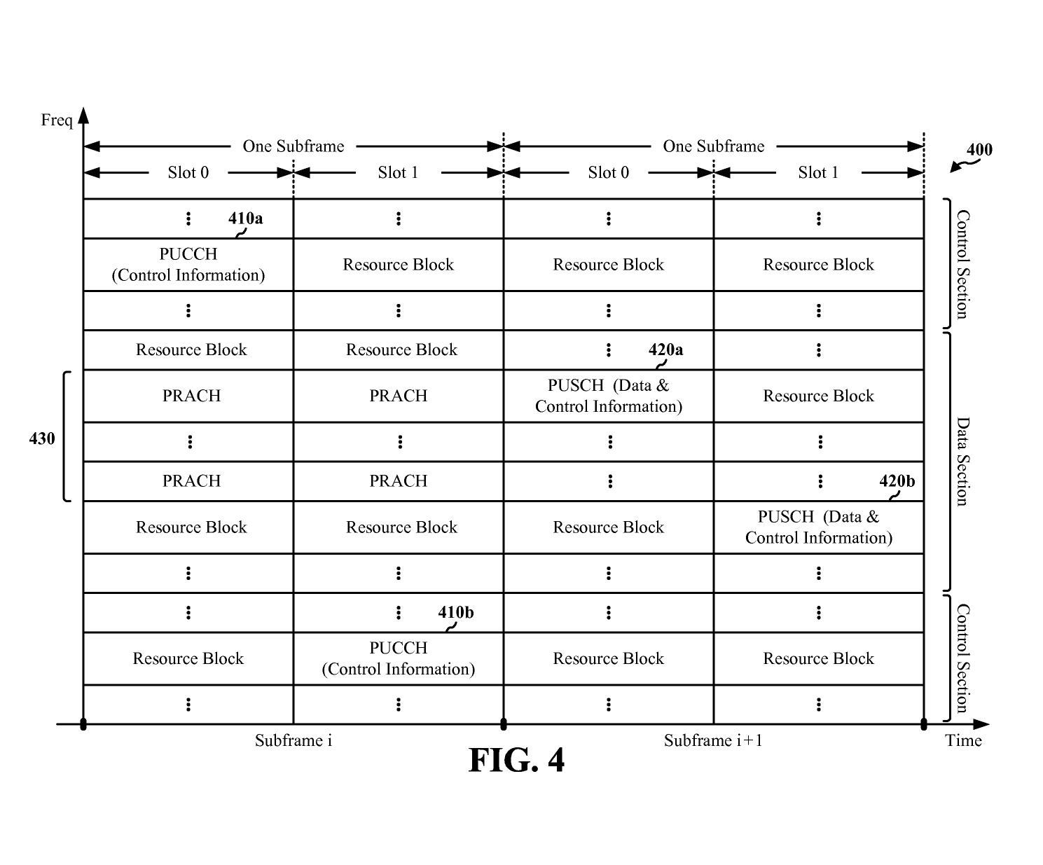

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

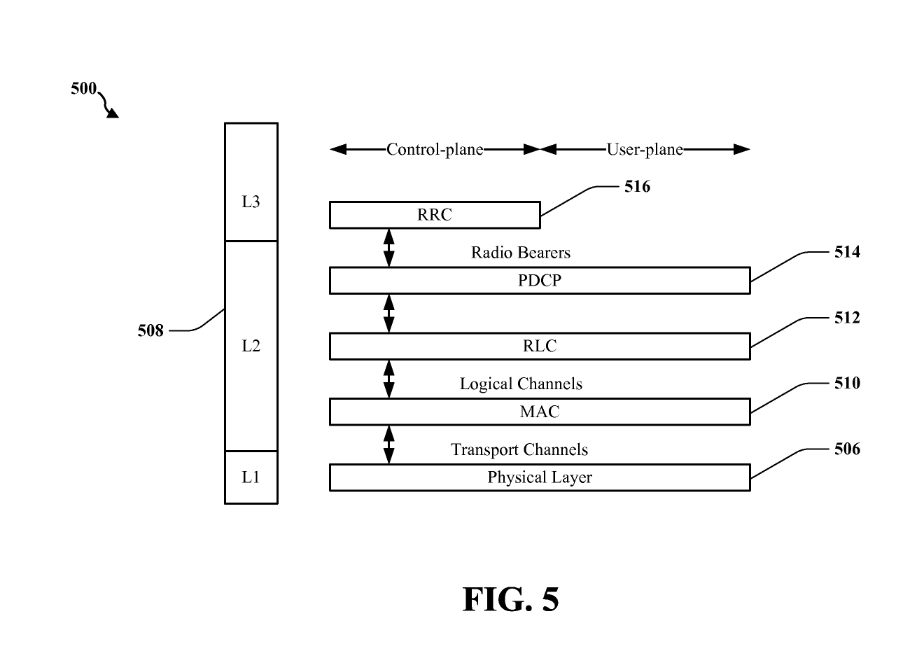

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARM). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (i.e., radio bearers) and for configuring the lower layers using RRC signaling between the eNB and the UE.

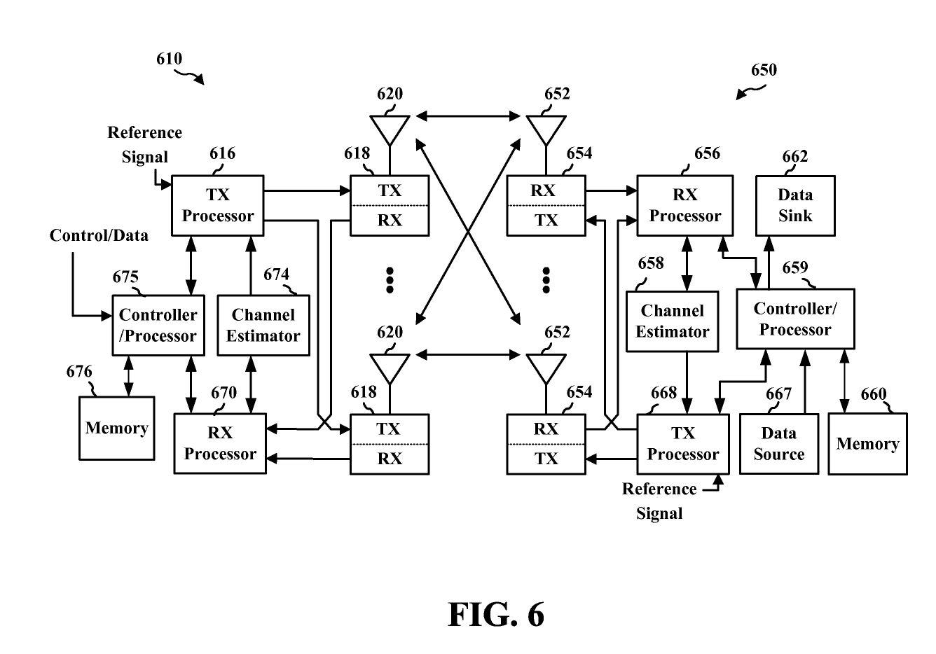

FIG. 6 is a block diagram of an eNB 610 in communication with a UE 650 in an access network. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The transmit (TX) processor 616 implements various signal processing functions for the L1 layer (i.e., physical layer). The signal processing functions includes coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream is then provided to a different antenna 620 via a separate transmitter 618TX. Each transmitter 618TX modulates an RF carrier with a respective spatial stream for transmission.

At the UE 650, each receiver 654RX receives a signal through its respective antenna 652. Each receiver 654RX recovers information modulated onto an RF carrier and provides the information to the receive (RX) processor 656. The RX processor 656 implements various signal processing functions of the L1 layer. The RX processor 656 performs spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 are provided to different antenna 652 via separate transmitters 654TX. Each transmitter 654TX modulates an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the control/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

The time period over which data blocks are encoded for physical transmission may be expressed as the transmission time interval (TTI). The TTI may also represent the minimum time required for a MAC protocol data unit (PDU) to be passed down to the physical layer for transmission. TTI bundling may be employed to improve uplink coverage by repeatedly coding and transmitting multiple copies of the same transport block or packet in a group of subframes (e.g. TTI), each copy being a redundancy version (RV) of the transport block. The group of subframes, or “TTI bundle,” are conventionally transmitted in consecutive subframes. Transmission of multiple RVs in a TTI bundle can lead to reduced transmission delay under certain channel conditions.

Each transmission of an RV in a TTI bundle is performed within the same HARQ process and the TTI bundle is treated as a single resource provided in a grant with a single HARQ feedback. For example, each RV in the TTI bundle may be transmitted until an ACK is received.

Conventional systems use a fixed bundling size of 4 TTIs. Inflexible bundling size configuration means that, for some UEs, there can be excessive bundling leading to system capacity loss, while other cell-edge UEs may actually require multiple bundled retransmission to achieve the desired error rate. Additionally, bundling is conventionally configured at upper layers and cannot be adapted depending on traffic. In conventional systems, time diversity is limited when bundling is used because combining gain due to fading diversity in the time domain is limited because bundling involves consecutive TTIs.

Certain embodiments employ an enhanced HARQ compression system, which addresses deficiencies observed in conventional bundling schemes. A more flexible bundling size may be provided as a function of the UE radio conditions rather than the conventional fixed bundling size of 4 TTIs. Bundling may be enabled for low-rate, low-latency traffic such as voice over IP (VoIP), and bundling may be disabled for high-rate, best-effort traffic, for the same UE.

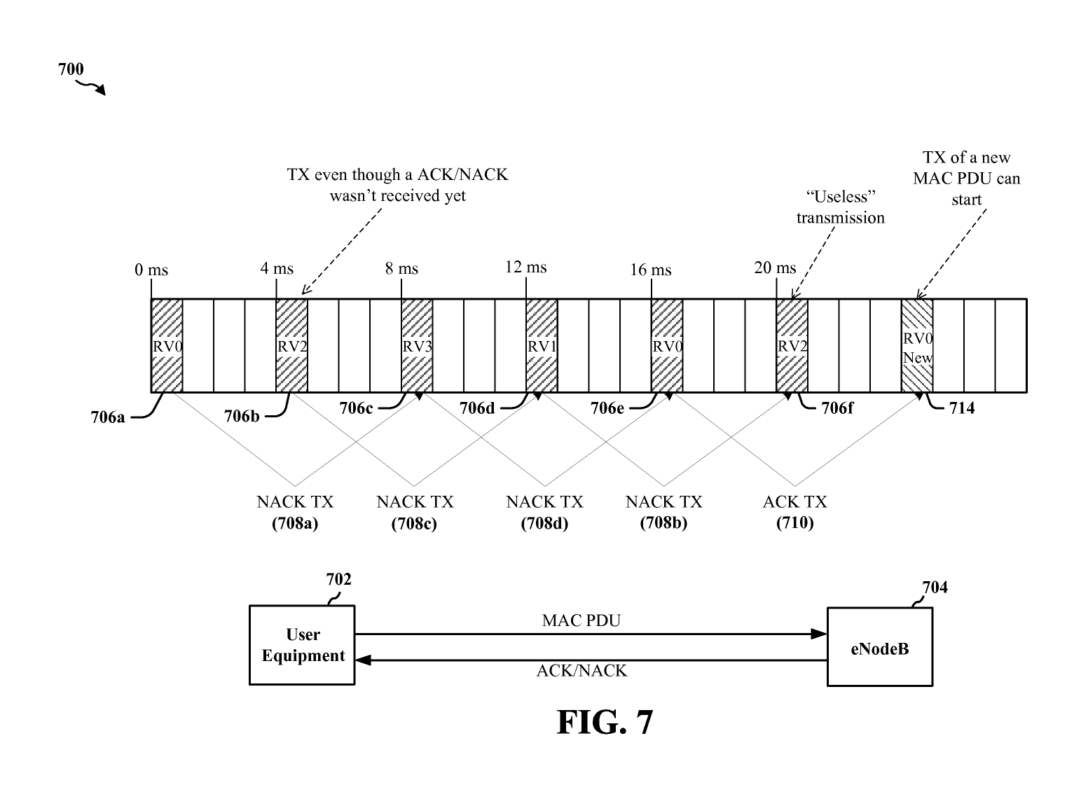

FIG. 7 is a timeline diagram 700 illustrating one HARQ compression method disclosed herein. In some embodiments, the TX HARQ timeline may be compressed without changing HARQ processing requirements at the UE 702, or at the eNB 704 through the use of normal UL PUSCH operations without bundling. The UE 702 may be mandated to re-transmit a packet according to the compressed timeline, without waiting for HARQ response for the previous transmission to be decoded. In the example, the UL re-transmission interval is compressed from 8 ms to 4 ms. In the example, different RVs 706a-706f of the same MAC PDU are transmitted in subframes 4 ms apart, commencing at times t₀ at 0 ms, t₄ at 4 ms, t₈ at 8 ms, t₁₂ at 12 ms, t₁₆ at 16 ms, t₂₀ at 20 ms, etc, without waiting for processing of a response to the previous RV 706a, 706b, 706c, 706d, 706e, or 706f. The response to each RV 706a, 706b, 706c or 706d is expected to have been processed 8 ms after transmission begins at time tₙ, based on a 4 ms period for the receiving eNB 704 to decode the RV 706a, 706b, 706c, 706d, 706e, or 706f, transmit the response at time tₙ+4 ms and a 4 ms period for the UE 702 to decode the response 706a, 706b, 706c, 706d, 706e, or 706f. In the example, the eNB 704 is able to successfully decode the MAC PDU after five transmissions by the UE 702.

In the example, UE 702 autonomously transmits TTI at t₄ RV version 2 (RV2) of the MAC PDU originally sent in the TTI at t₀ (separated by 4 ms, or 4 TTIs). The transmission of RV0, RV1, RV2 and RV3 in multiple TTIs is transmitted under a single UL assignment which grants transmission over multiple TTIs. A reduced DL control overhead may be achieved because a single grant guarantees multiple UL transmissions. The final RV transmission, which is RV2 at t₂₀ in the example, may be relatively useless, because the eNB 704 has successfully decoded the MAC PDU after the first 5 transmissions. Although, it may be assumed that the UE 702 has recognized the receipt of ACK 710 for the 5th transmission after t₂₀, where it is supposed to re-transmit RV2 of the original MAC PDU, RV2 may transmitted to maintain consistency with the predefined HARQ timeline. This “excess” transmission is a consequence of bundling transmissions. However, the HARQ compression methods disclosed herein are typically more efficient and effective than conventional bundling schemes.

In the example of FIG. 7, only 4 HARQ processes are required if all transmissions follow the described timeline. Note, however, that the 4 ms compressed timeline is provided as one of many examples. For example, the intervals between transmissions may be reduced from 4 ms to 2 ms and only 2 HARQ processes are then required.

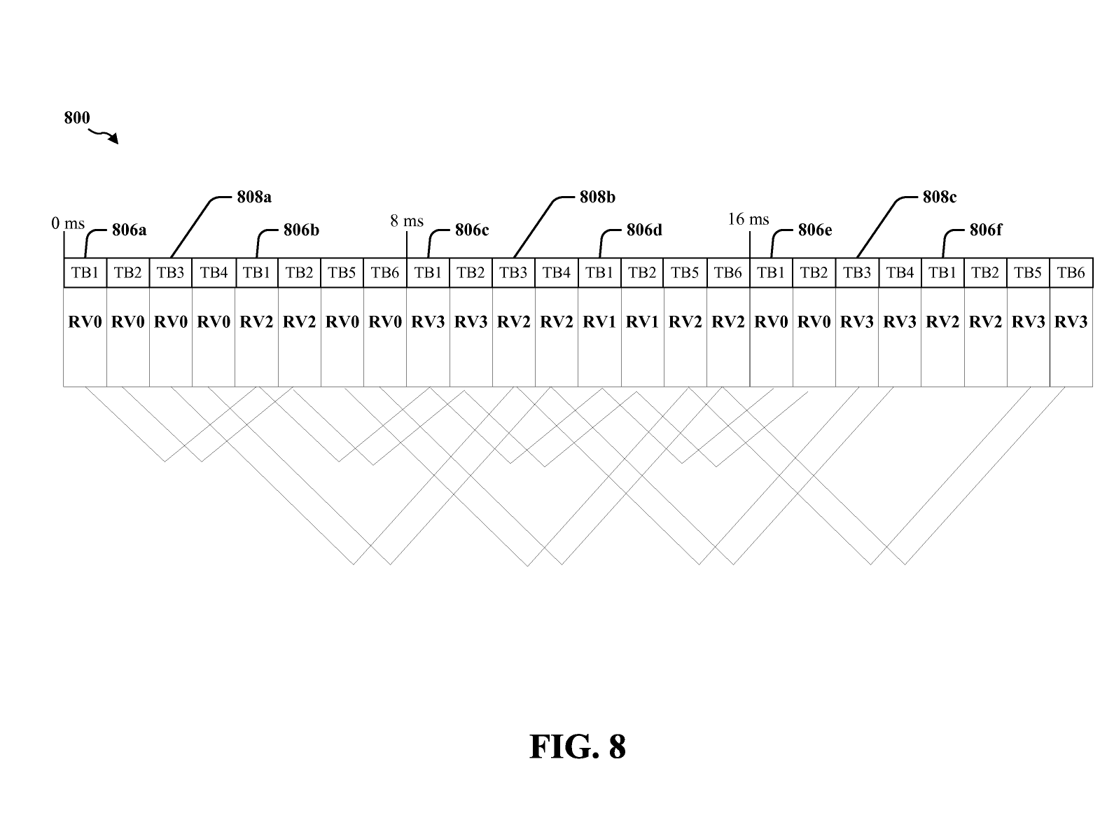

FIG. 8 illustrates another example 800 in which multiple HARQ processes are used and more than one transmission timeline is supported. In FIG. 8, it may be assumed that eNB 704 and UE 702 have negotiated rules through upper layer signaling. For example, a rule may be negotiated whereby bundling is performed with a compressed 4 ms timeline when the first UL transmission of a first PDU occurs at a subframe number (SFN₁) SFN₁ modulo 8==0 or 1. In one example, the first RV 806a transmitted for a PDU TB1 is followed by automatic retransmissions 806b-806f that may occur at 4 ms intervals.

The rule may also dictate bundling certain PDUs with an 8 ms timeline when the first UL transmission of a first PDU occurs at a subframe number (SFN₂) where SFN₂ modulo 4≠0 or 1. In one example, a first RV 808a transmitted for a PDU TB3 is followed by automatic retransmissions 808b and 808c that may occur at 8 ms intervals. In the example depicted in FIG. 8, 6 HARQ processes are employed.

The number of “useless retransmissions” may be limited to a single “excess” transmission. In contrast, conventional systems may experience excess transmissions that are one less than the fixed TTI bundle size, with corresponding wasted UL system resources that may result in significant overhead.

In some embodiments, time diversity is achieved because automatic, bundled retransmissions may be spaced by one or more TTIs. In the example of FIG. 7, the spacing is 4 ms between transmissions. Since channel conditions typically persist or change little between consecutive time slots, the spaced retransmissions described herein may significantly improve time diversity.

As discussed in relation to FIG. 8, for example, flexibility of bundling is provided that enables straightforward allocation of concurrent bundled/non-bundled transmissions for the same UE 702. UL resources are used efficiently since all subframes can be used. Moreover, no additional HARQ processes are needed to implement the disclosed HARQ compression methods over conventional methods and no increased complexity is consequently needed.

It will be appreciated that the presently disclosed HARQ compression method may increase loading of the physical hybrid ARQ indicator channel (PHICH). PHICH is the physical DL channel that carries the HARQ ACK/NACK information indicating whether eNB 704 has correctly received a transmission on a PUSCH. In certain embodiments, an ACK/NACK per TTI is used, thereby increasing PHICH loading with respect to conventional bundling methods in which a single ACK/NACK is fed back for a whole bundle. However, PHICH loading is typically no worse than would be seen in non-bundled communication.

Some embodiments may increase overall efficiency by reducing or eliminating the occurrence of “wasted” or “excess” DL ACK/NACK transmissions. Excess transmissions may be reduced using predictive techniques at the eNB 704 to anticipate the receipt of an ACK from the UE 702. For example, the eNB 704 may estimate the probability that the next RV transmitted and/or processed will allow the eNB 704 to successfully decode the MAC PDU. In one example, the probability may be estimated based on the reliability of received LLRs. An LLR provides information about the most likely value of the bit and about the reliability of that estimate and the probability may be based on LLRs received for the current bundle. When the probability exceeds a predefined or a preconfigured threshold, above which the eNB 704 transmits an ACK at time tₙ under the assumption that the PUSCH payload that will be received at time tₙ+4 ms will allow successful decoding of the PDU when the LLR of the RV in the PUSCH payload of tₙ+4 ms is combined with the LLRs of RVs already received. When the prediction succeeds, the “useless” transmission at the end of the bundle can be eliminated, thereby further improving the system capacity.

In some embodiments, an algorithm for ACK/NACK prediction at a receiver of the eNB 704 may be constructed using one or more of captured LLR average energy, captured LLR average magnitude, intrinsic information in the LLRs, a number of errors determined after turbo decoding, an average combined SINR, etc.

In certain embodiments an advanced TTI bundling pattern can be semi-statically configured, using RRC signaling to communicate a bitmap of predetermined length (e.g., length may be 8), or dynamically configured using one or more bit in a UL grant, for example, to indicate whether a bundled transmission shall be initiated by the UE 702. When bundling patterns are dynamically configured, timeline compression values, (e.g., a timeline value of 4 ms, 2 ms, etc.) may be indicated through RRC signaling. Advanced TTI bundling patterns may indicate which subframes are bundled, which subframes are not bundled, and so on.

In certain embodiments, frequency hopping is performed between automatic retransmissions. Thus, for example, consecutive RVs 706a and 706b may be transmitted using different combinations of frequency and/or frequency bands.

In certain embodiments, the disclosed HARQ timeline compression approach co-exists with semi-persistent scheduling (SPS). SPS may be used to semi-statically configure and allocate radio resources to UE 704 for a period of time that is longer than one subframe. SPS may limit the number of specific downlink assignment messages and/or uplink grant messages over the PDCCH for each subframe. SPS may be used for fixed rate services such as VoIP, where the timing and quantity of radio resources needed are predictable. When UL SPS is active, UE 704 may be provided with periodic UL assignments without explicit PDCCH grants. Periodicity and other scheduling parameters may be configured by upper layers. In certain embodiments, HARQ timeline compression can co-exist with SPS and can tolerate the absence of explicit UL grants transmitted by the eNB 702. In some embodiments, one or more collision avoidance techniques ensure that multiple transmission opportunities do not collide with new packet transmissions determined according to the SPS periodicity. In one example, the UE 702 may be provided with information identifying a maximum number of transmissions. When a 4 ms autonomous retransmission interval is used with a 20 ms SPS periodicity, a maximum number of 5 transmissions may be permitted. In another example, the SPS periodicity and the autonomous re-transmission period may be selected to be prime numbers, so that collisions are prevented for re-transmissions that are low in number. Typically, prime numbers are selected such that the least common multiple of the two periodicities is maximized.

In certain embodiments, the disclosed HARQ timeline compression approach co-exists with discontinuous reception (DRX). DRX occurs when a receiver is periodically disabled, usually for the purpose of conservation of power. DRX cycles may be configured in the DL such that UE 702 need not decode PDCCH, or receive PDSCH transmissions in certain subframes. The UE 702 typically enters DRX mode when several conditions configured by upper layers are satisfied. The conditions may include the absence of any pending UL retransmission. Accordingly, the disclosed HARQ compression techniques have no impact on DRX, since in either case the UE 702 enter DRX only when all recent UL transmissions have been ACKed by the eNB 704. Thus, ACK/NACK transmission and reception timelines are not affected.

In certain embodiments, the disclosed HARQ timeline compression approach co-exists with conventional, TTI bundling. UEs 702 that support the disclosed bundling approach may coexist with legacy UEs (not shown) and be associated to the same eNB 704. Multiple bundling techniques may be supported without incurring performance penalties or waste of system resources by assigning legacy UEs with TTI bundling and UEs 702 with HARQ compression to different PRBs for UL transmissions. When assigned to separate PRBs, conflicts can be avoided between the legacy UEs and UEs 702 because of the different HARQ timelines. Intermixing of different bundling types in the same frequency resources may result in collisions, which may be avoided by wasting some UL TTIs, which are unusable by any UE. Moreover, bundling is typically used with very small PRB assignments, thus allocating different PRBs to different UEs is easily accomplished.

In one example embodiment, VoIP packets are generated every 20 ms and a maximum delay of 50 ms is dictated for the VoIP packets. For this combination of delay and repetition, several HARQ timeline compression values may be used, and compression values may be selected based on a consideration of tradeoffs between coverage and system utilization. For example, a timeline spacing of 3 ms, whereby a VoIP packet received from upper layers at subframe occurring at time 20n ms, may be transmitted by the UE 702 using different RVs, in subframes occurring at 20n ms, (20n+3) ms, (20n+6) ms, . . . , (20n+48) ms. The same MAC PDU, with cyclically changing RV, may be transmitted up to 17 times while fulfilling the maximum delay constraint. The transmissions are typically uniformly distributed in time. Based on HARQ feedback provided by the eNB 704, fewer than 17 transmissions are typically required. Absent the use of ACK/NACK prediction techniques described herein, 2 or 3 transmissions may be wasted. The average number of wasted transmission can be close to zero when an efficient prediction scheme is used at the eNB 704. Optimal diversity gain can be achieved due to time-domain combining and the use of uniformly distributed transmissions in the time domain. In the example, the use of 3 ms spacing avoids collision between pending retransmissions and new VoIP packets because the next two VoIP packets are received for transmission at subframes occurring at times 20n+20 ms and 20n+40 ms, neither of which TTIs is used by any re-transmission of the VoIP packet generated in the subframe occurring at time 20n ms.

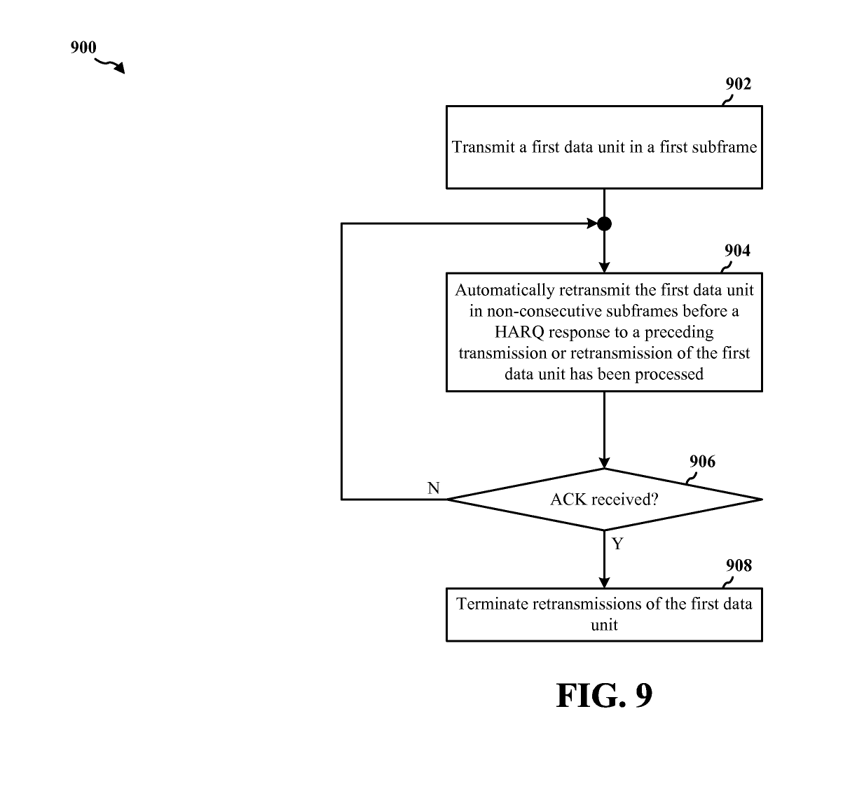

FIG. 9 is a flow chart 900 of a method of wireless communication. The method may be performed by a UE 702. At step 902, the UE 702 transmits a first data unit in a first subframe. The first data unit may be transmitted as one of a plurality of redundancy versions of the first data unit.

At step 904, the UE 702 automatically retransmits the first data unit in one or more non-consecutive subframes before a HARQ response to a preceding transmission or retransmission of the first data unit has been processed. The automatic retransmissions may occur periodically. A predetermined number of intervening subframes may be transmitted before each retransmission of the first data unit. The first data unit may be retransmitted using the plurality of redundancy versions of the first data unit. Redundancy versions may be selected for use in accordance with a cyclic selection scheme, or other selection scheme.

In some embodiments, the UE 702 may transmit and automatically retransmit a second data unit in a plurality of the intervening subframes until a processed HARQ response to the transmission or the retransmission of the second data unit is determined to comprise an ACK. The second data unit may be transmitted and retransmitted in non-consecutive subframes. A number of intervening subframes may be transmitted before each retransmission of the second data unit. The same number of intervening subframes may be transmitted before retransmissions of the first and second data units. A different number of intervening subframes is transmitted before retransmissions of the first and second data units. The second data unit may be transmitted and retransmitted using a plurality of redundancy versions of the second data unit.

At step 906, the UE 702 determines whether an ACK has been received and processed by the UE 702. If no ACK has been received, the UE 702 may automatically retransmit the data unit at step 904.

If an ACK is processed by the UE 702, then at step 908, the UE 702 terminates retransmissions of the first data unit.

In some embodiments, retransmissions of the first data unit are terminated after a predetermined maximum number of retransmissions. A maximum delay may be defined for the first data unit. The maximum number of retransmissions may be determined based on the maximum delay. The maximum number of retransmissions may be determined based on a number of intervening subframes that are transmitted before each retransmission of the first data unit. The first data unit may comprise voice data. The first data unit may comprise VoIP data.

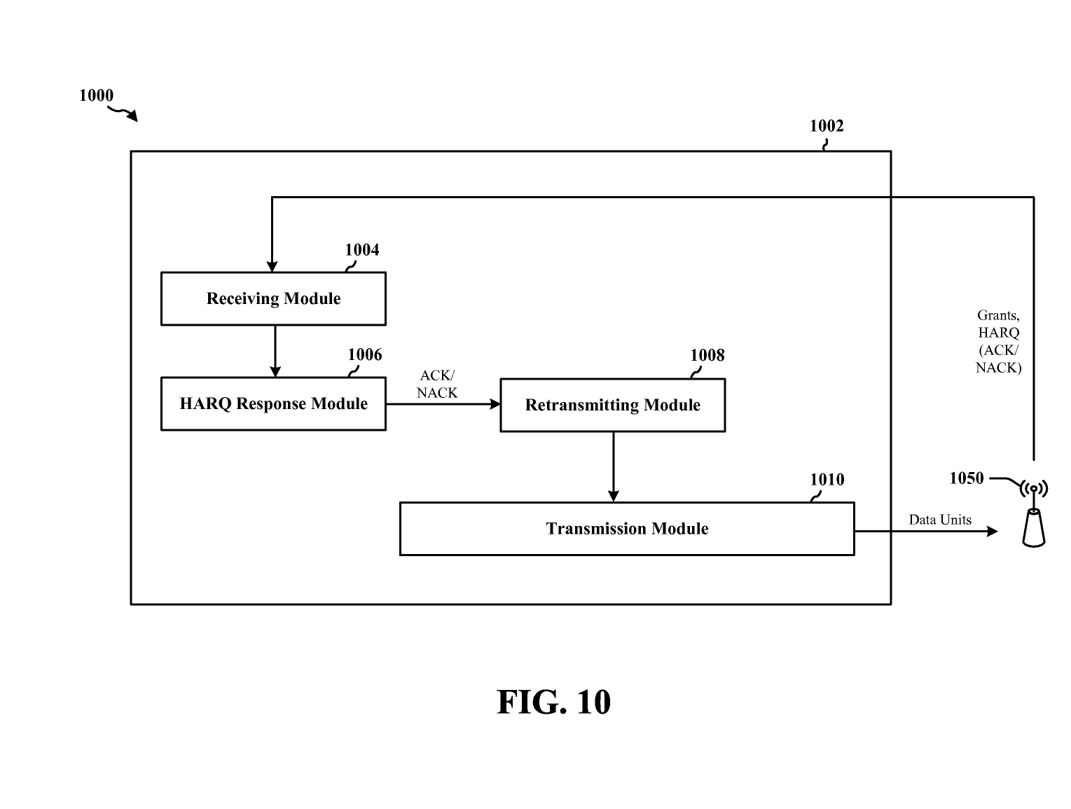

FIG. 10 is a conceptual data flow diagram 1000 illustrating the data flow between different modules/means/components in an exemplary apparatus 1002. The apparatus may be a UE. The apparatus 1002 includes a transmission module 1010, a retransmitting module 1008, a receiving module 1004, and a HARQ response module 1006. These modules function together to perform the steps of the algorithm in the aforementioned flow chart of FIG. 9. The transmission module 1010 transmits data units to an eNB 1050. The retransmitting module 1008 causes the transmission module 1010 to automatically retransmit certain data units. The receiving module 1004 receives UL grants, HARQ responses and other communications from the eNB 1050. The HARQ response module 1006 processes HARQ responses from the eNB 1050.

The apparatus 1002 may include additional modules that perform each of the steps of the algorithm in the aforementioned flow chart of FIG. 9. As such, each step in the aforementioned flow chart of FIG. 9 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

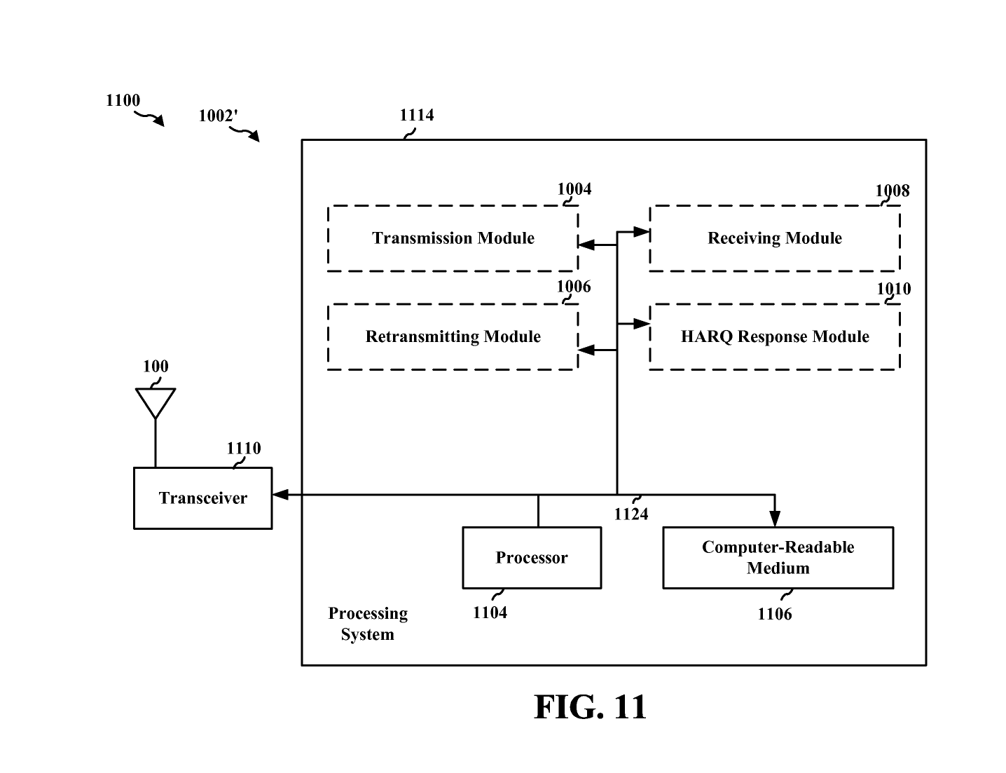

FIG. 11 is a diagram 1100 illustrating an example of a hardware implementation for an apparatus 1002′ employing a processing system 1114. The processing system 1114 may be implemented with a bus architecture, represented generally by the bus 1124. The bus 1124 may include any number of interconnecting buses and bridges depending on the specific application of the processing system 1114 and the overall design constraints. The bus 1124 links together various circuits including one or more processors and/or hardware modules, represented by the processor 1104, the modules 1004, 1006, 1008, 1010, and the computer-readable medium 1106. The bus 1124 may also link various other circuits such as timing sources, peripherals, voltage regulators, and power management circuits, which are well known in the art, and therefore, will not be described any further.

The processing system 1114 may be coupled to a transceiver 1110. The transceiver 1110 is coupled to one or more antennas 1120. The transceiver 1110 provides a means for communicating with various other apparatus over a transmission medium. The processing system 1114 includes a processor 1104 coupled to a computer-readable medium 1106. The processor 1104 is responsible for general processing, including the execution of software stored on the computer-readable medium 1106. The software, when executed by the processor 1104, causes the processing system 1114 to perform the various functions described supra for any particular apparatus. The computer-readable medium 1106 may also be used for storing data that is manipulated by the processor 1104 when executing software. The processing system further includes at least one of the modules 1004, 1006, 1008, and 1010. The modules may be software modules running in the processor 1104, resident/stored in the computer readable medium 1106, one or more hardware modules coupled to the processor 1104, or some combination thereof. The processing system 1114 may be a component of the UE 650 and may include the memory 660 and/or at least one of the TX processor 668, the RX processor 656, and the controller/processor 659.

In one configuration, the apparatus 1002/1002′ for wireless communication includes means for transmitting a first data unit in a first subframe, means for automatically retransmitting the first data unit in one or more non-consecutive subframes before a HARQ response to a preceding transmission or retransmission of the first data unit has been processed, means for terminating retransmissions of the first data unit configured to terminate the retransmissions after a processed HARQ response is determined to comprise an ACK, and means for receiving the HARQ response.

The aforementioned means may be one or more of the aforementioned modules of the apparatus 1002 and/or the processing system 1114 of the apparatus 1002′ configured to perform the functions recited by the aforementioned means. As described supra, the processing system 1114 may include the TX Processor 668, the RX Processor 656, and the controller/processor 659. As such, in one configuration, the aforementioned means may be the TX Processor 668, the RX Processor 656, and the controller/processor 659 configured to perform the functions recited by the aforementioned means.

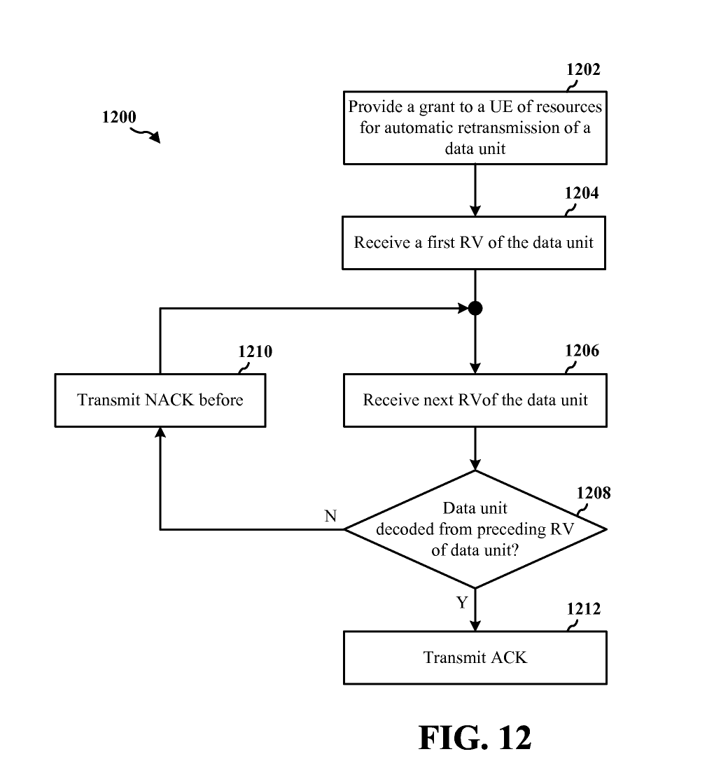

FIG. 12 is a flow chart 1200 of a method of wireless communication. The method may be performed by an eNB 704. At step 1202, the eNB 704 provides a grant to a UE 702. The grant may provide resources for automatic retransmission of a data unit. The grant may define a number of intervening subframes to be transmitted by the UE before each transmission of a redundancy version of the data unit. The grant may define a maximum number of transmissions of redundancy versions of the data unit. The maximum number of transmissions may be based on a maximum delay permitted for the data unit. The first data unit may comprise voice data. The first data unit may comprise VoIP data.

At step 1204, the eNB 704 receives a first redundancy version of the data unit. At step 1206, the eNB 704 receives a next redundancy version of the data unit. At step 1208, and before receiving and/or processing the next redundancy version of the data unit, the eNB 704 determines whether the data unit has been decoded from the preceding redundancy versions of the data unit.

If the data unit has not been successfully decoded, then at step 1210, the eNB 704 may transmit a NACK as a HARQ response to the preceding redundancy version of the data unit. The NACK may be sent while concurrently receiving and/or processing the next redundancy version of the data.

If the data unit has been successfully decoded, then at step 1212, the eNB 704 may transmit an ACK as a HARQ response to the preceding redundancy version of the data unit. The ACK may be sent while concurrently receiving and/or processing the next redundancy version of the data. The ACK may be transmitted when the data unit can be derived from the plurality of redundancy versions of the data unit.

In some embodiments, an ACK may be sent even if the data unit has not been successfully decoded. The eNB 704 may calculate or otherwise determine a probability that the data unit can be derived from a next redundancy version of the data unit. An ACK may be transmitted as the HARQ response when the probability exceeds a threshold and before the next redundancy version of the data unit is processed. The probability may be determined based on previously received LLRs. The probability may be determined based on one or more of LLR average energy, LLR average magnitude, intrinsic information in a plurality of LLRs, a number of errors determined after turbo decoding, and an average combined signal-to-interference-and-noise ratio.

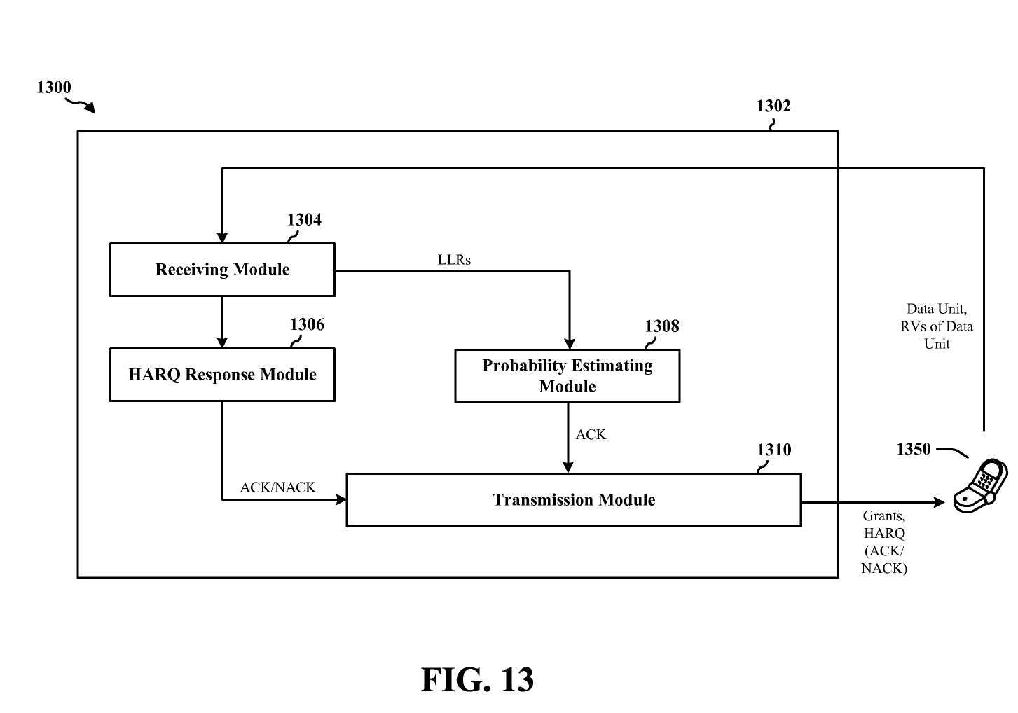

FIG. 13 is a conceptual data flow diagram 1300 illustrating the data flow between different modules/means/components in an exemplary apparatus 1302. The apparatus may be an eNB. The apparatus 1302 includes a receiving module 1304, a HARQ response module 1306, a probability calculating module 1308, and a transmission module 1310. These modules function together to perform the steps of the algorithm in the aforementioned flow chart of FIG. 12. The receiving module 1304 receives redundancy versions of a data unit from a UE 1350. The HARQ response module 1306 determines if the data unit has been successfully decoded. The probability calculating module 1308 optionally determines the likelihood that the data unit will be decoded after processing a next redundancy version of the data unit. The transmission module 1310 transmits grants and HARQ responses to the UE 1350.

The apparatus may include additional modules that perform each of the steps of the algorithm in the aforementioned flow chart of FIG. 12. As such, each step in the aforementioned flow chart of FIG. 12 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

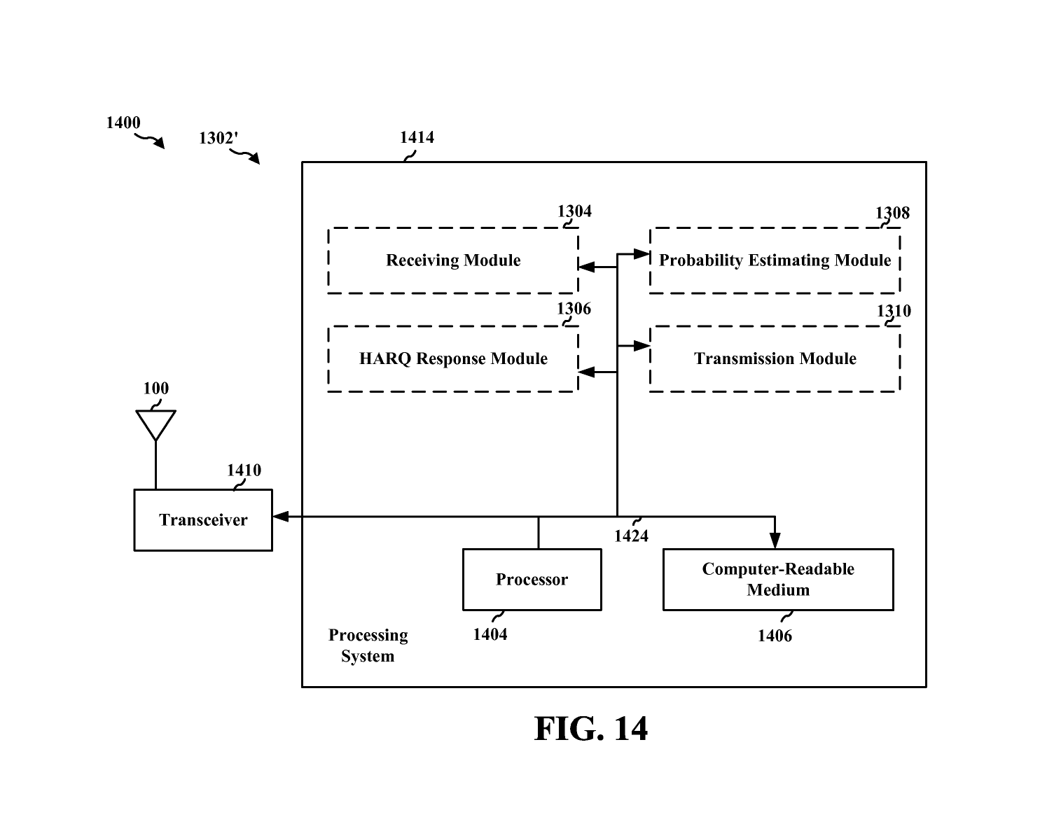

FIG. 14 is a diagram 1400 illustrating an example of a hardware implementation for an apparatus 1302′ employing a processing system 1414. The processing system 1414 may be implemented with bus architecture, represented generally by the bus 1424. The bus 1424 may include any number of interconnecting buses and bridges depending on the specific application of the processing system 1414 and the overall design constraints. The bus 1424 links together various circuits including one or more processors and/or hardware modules, represented by the processor 1404, the modules 1304, 1306, 1308, 1310, and the computer-readable medium 1406. The bus 1424 may also link various other circuits such as timing sources, peripherals, voltage regulators, and power management circuits, which are well known in the art, and therefore, will not be described any further.

The processing system 1414 may be coupled to a transceiver 1410. The transceiver 1410 is coupled to one or more antennas 1420. The transceiver 1410 provides a means for communicating with various other apparatus over a transmission medium. The processing system 1414 includes a processor 1404 coupled to a computer-readable medium 1406. The processor 1404 is responsible for general processing, including the execution of software stored on the computer-readable medium 1406. The software, when executed by the processor 1404, causes the processing system 1414 to perform the various functions described supra for any particular apparatus. The computer-readable medium 1406 may also be used for storing data that is manipulated by the processor 1404 when executing software. The processing system further includes at least one of the modules 1304, 1306, 1308, and 1310. The modules may be software modules running in the processor 1404, resident/stored in the computer readable medium 1406, one or more hardware modules coupled to the processor 1404, or some combination thereof. The processing system 1414 may be a component of the eNB 610 and may include the memory 676 and/or at least one of the TX processor 616, the RX processor 670, and the controller/processor 675.

In one configuration, the apparatus 1302/1302′ for wireless communication includes means for providing a grant to a UE, means for receiving redundancy versions of a data unit, means for transmitting HARQ responses, and means for calculating the probability that the data unit may be decoded after processing the next redundancy version of the data unit.

The aforementioned means may be one or more of the aforementioned modules of the apparatus 1302 and/or the processing system 1414 of the apparatus 1302′ configured to perform the functions recited by the aforementioned means. As described supra, the processing system 1414 may include the TX Processor 616, the RX Processor 670, and the controller/processor 675. As such, in one configuration, the aforementioned means may be the TX Processor 616, the RX Processor 670, and the controller/processor 675 configured to perform the functions recited by the aforementioned means.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of wireless communication, comprising:
transmitting a first data unit in a first subframe using one of a plurality of redundancy versions of the first data unit;
automatically retransmitting the first data unit in non-consecutive subframes using the plurality of redundancy versions of the first data unit, wherein the first data unit is retransmitted before a hybrid automatic repeat request (HARQ) response to a preceding transmission or retransmission of the first data unit has been processed; and
terminating retransmissions of the first data unit after a processed HARQ response is determined to comprise an acknowledgement (ACK).

2. The method of claim 1, wherein the automatic retransmissions occur periodically.

3. The method of claim 2, wherein a predetermined number of intervening subframes are transmitted before each retransmission of the first data unit.

4. The method of claim 3, further comprising transmitting and automatically retransmitting a second data unit using redundancy versions of the second data unit in a plurality of the intervening subframes until a processed HARQ response to the transmission or the retransmission of the second data unit is determined to comprise an ACK.

5. The method of claim 4, wherein the second data unit is transmitted and retransmitted in non-consecutive subframes.

6. The method of claim 5, wherein a number of intervening subframes are transmitted before each retransmission of the second data unit.

7. The method of claim 6, wherein the same number of intervening subframes is transmitted before retransmissions of the first and second data units.

8. The method of claim 6, wherein a different number of intervening subframes is transmitted before retransmissions of the first and second data units.

9. The method of claim 1, further comprising terminating retransmissions of the first data unit after a predetermined maximum number of retransmissions.

10. The method of claim 9, wherein a maximum delay is defined for the first data unit, and wherein the maximum number of retransmissions is determined based on the maximum delay.

11. The method of claim 10, wherein the maximum number of retransmissions is determined based on a number of intervening subframes that are transmitted before each retransmission of the first data unit.

12. The method of claim 10, wherein the first data unit comprises voice data.

13. The method of claim 10, wherein the first data unit comprises voice over IP (VoIP) data.

14. An apparatus for wireless communication, comprising:
means for transmitting a first data unit in a first subframe using one of a plurality of redundancy versions of the first data unit;
means for automatically retransmitting the first data unit in non-consecutive subframes using the plurality of redundancy versions of the first data unit, wherein the first data unit is retransmitted before a hybrid automatic repeat request (HARQ) response to a preceding transmission or retransmission of the first data unit has been processed; and
means for terminating retransmissions of the first data unit after a processed HARQ response is determined to comprise an acknowledgement (ACK).

15. The apparatus of claim 14, wherein the automatic retransmissions occur periodically.

16. The apparatus of claim 15, wherein a predetermined number of intervening subframes are transmitted before each retransmission of the first data unit.

17. The apparatus of claim 16, wherein the means for transmitting and means for automatically retransmitting transmit and retransmit a second data unit using redundancy versions of the second data unit in a plurality of the intervening subframes until a processed HARQ response to the transmission or the retransmission of the second data unit is determined to comprise an ACK.

18. The apparatus of claim 17, wherein the second data unit is transmitted and retransmitted in non-consecutive subframes.

19. The apparatus of claim 18, wherein a number of intervening subframes are transmitted before each retransmission of the second data unit.

20. The apparatus of claim 19, wherein the same number of intervening subframes is transmitted before retransmissions of the first and second data units.

21. The apparatus of claim 19, wherein a different number of intervening subframes is transmitted before retransmissions of the first and second data units.

22. The apparatus of claim 14, wherein the means for terminating retransmissions of the first data unit is further configured to terminate the retransmissions after a predetermined maximum number of retransmissions.

23. The apparatus of claim 22, wherein a maximum delay is defined for the first data unit, and wherein the maximum number of retransmissions is determined based on the maximum delay.

24. The apparatus of claim 23, wherein the maximum number of retransmissions is determined based on a number of intervening subframes that are transmitted before each retransmission of the first data unit.

25. The apparatus of claim 23, wherein the first data unit comprises voice data.

26. The apparatus of claim 23, wherein the first data unit comprises voice over IP (VoIP) data.

27. An apparatus for wireless communication, comprising:
a processing system configured to:
transmit a first data unit in a first subframe using one of a plurality of redundancy versions of the first data unit;
automatically retransmit the first data unit in non-consecutive subframes using the plurality of redundancy versions of the first data unit, wherein the first data unit is retransmitted before a hybrid automatic repeat request (HARQ) response to a preceding transmission or retransmission of the first data unit has been processed; and
terminate retransmissions of the first data unit after a processed HARQ response is determined to comprise an acknowledgement (ACK).

28. A computer program product, comprising:
a computer-readable medium comprising code for:
transmitting a first data unit in a first subframe using one of a plurality of redundancy versions of the first data unit;
automatically retransmitting the first data unit in non-consecutive subframes using the plurality of redundancy versions of the first data unit, wherein the first data unit is retransmitted before a hybrid automatic repeat request (HARQ) response to a preceding transmission or retransmission of the first data unit has been processed; and
terminating retransmissions of the first data unit after a processed HARQ response is determined to comprise an acknowledgement (ACK).

29. A method of wireless communication, comprising:
providing a grant to a user equipment (UE), the grant providing resources for automatic retransmission of a data unit;
receiving a first redundancy version of the data unit;
transmitting a hybrid automatic repeat request (HARQ) response to the first redundancy version of the data unit; and
receiving a second redundancy version of the data unit while concurrently transmitting the HARQ response.

30. The method of claim 29, further comprising transmitting a negative acknowledgement (NACK) as a HARQ response to each of a plurality of redundancy versions of the data unit, the plurality of redundancy version including the first and second redundancy versions of the data unit.

31. The method of claim 30, further comprising transmitting an acknowledgement (ACK) as a HARQ response when the data unit can be derived from the plurality of redundancy versions of the data unit.

32. The method of claim 30, wherein the grant defines a number of intervening subframes to be transmitted by the UE before each transmission of a redundancy version of the data unit.

33. The method of claim 29, wherein the grant defines a maximum number of transmissions of redundancy versions of the data unit.

34. The method of claim 33, wherein the maximum number of transmissions is based on a maximum delay permitted for the data unit.

35. The method of claim 34, wherein the first data unit comprises voice data.

36. The method of claim 34, wherein the first data unit comprises voice over IP data.

37. The method of claim 29, further comprising:
determining a probability that the data unit can be derived from a next redundancy version of the data unit; and
transmitting an ACK as a HARQ response when the probability exceeds a threshold and before the next redundancy version of the data unit is processed.

38. The method of claim 37, wherein the probability is determined based on previously received log-likelihood ratios (LLRs).

39. The method of claim 37, wherein the probability is determined based on one or more of LLR average energy, LLR average magnitude, intrinsic information in a plurality of LLRs, a number of errors determined after turbo decoding, and an average combined signal-to-interference-and-noise ratio.

40. An apparatus for wireless communication, comprising:
means for providing a grant to a user equipment (UE), the grant providing resources for automatic retransmission of a data unit;
means for receiving a first redundancy version of the data unit;
means for transmitting a hybrid automatic repeat request (HARQ) response to the first redundancy version of the data unit; and
means for receiving a second redundancy version of the data unit while concurrently transmitting the HARQ response.

41. The apparatus of claim 40, further comprising transmitting a negative acknowledgement (NACK) as a HARQ response to each of a plurality of redundancy versions of the data unit, the plurality of redundancy version including the first and second redundancy versions of the data unit.

42. The apparatus of claim 41, further comprising transmitting an acknowledgement (ACK) as a HARQ response when the data unit can be derived from the plurality of redundancy versions of the data unit.

43. The apparatus of claim 40, wherein the grant defines a number of intervening subframes to be transmitted by the UE before each transmission of a redundancy version of the data unit.

44. The apparatus of claim 40, wherein the grant defines a maximum number of transmissions of redundancy versions of the data unit.

45. The apparatus of claim 44, wherein the maximum number of transmissions is based on a maximum delay permitted for the data unit.

46. The apparatus of claim 45, wherein the first data unit comprises voice data.

47. The apparatus of claim 45, wherein the first data unit comprises voice over IP data.

48. The apparatus of claim 40, further comprising:
determining a probability that the data unit can be derived from a next redundancy version of the data unit; and
transmitting an ACK as a HARQ response when the probability exceeds a threshold and before the next redundancy version of the data unit is processed.

49. The apparatus of claim 48, wherein the probability is determined based on previously received log-likelihood ratios (LLRs).

50. The apparatus of claim 48, wherein the probability is determined based on one or more of LLR average energy, LLR average magnitude, intrinsic information in a plurality of LLRs, a number of errors determined after turbo decoding, and an average combined signal-to-interference-and-noise ratio.

51. An apparatus for wireless communication, comprising:
a processing system configured to:
provide a grant to a user equipment (UE), the grant providing resources for automatic retransmission of a data unit;
receive a first redundancy version of the data unit;
transmit a hybrid automatic repeat request (HARQ) response to the first redundancy version of the data unit; and
receive a second redundancy version of the data unit while concurrently transmitting the HARQ response.

52. A computer program product, comprising:
a computer-readable medium comprising code for:
providing a grant to a user equipment (UE), the grant providing resources for automatic retransmission of a data unit;
receiving a first redundancy version of the data unit;
transmitting a hybrid automatic repeat request (HARQ) response to the first redundancy version of the data unit; and
receiving a second redundancy version of the data unit while concurrently transmitting the HARQ response.
